(19) United States
(12) Patent Application Publication
(10) Pub. No.: US 2008/0079674 A1
(43) Pub. Date: Apr. 3, 2008

(54) DISPLAY DEVICE AND METHOD FOR DRIVING THE SAME

(76) Inventors: Yoshihisa Ooishi, Yokohama (JP); Takashi Shoji, Fujisawa (JP); Junichi Maruyama, Yokohama (JP); Kikuo Ono, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/772,874

(22) Filed: Jul. 3, 2007

(30) Foreign Application Priority Data
Jul. 5, 2006 (JP) 2006-185107

(51) Int. Cl. G09G 3/36

(52) U.S. Cl. 345/87

(57) ABSTRACT

A range of higher applied voltage (lower applied voltage) than maximum (minimum) applied voltage, which is conventional maximum (minimum) liquid crystal transmittance, is provided; and the liquid crystal response compensator, which sets reference voltage, is provided so that the range can be utilized to compensate liquid crystal response; and the γ adjuster and the inter-tone interpolator are provided in order to adjust drift of γ characteristics caused by extension of the applied voltage range.

### CLAIM OF PRIORITY

The present application claims priority from Japanese application serial No. 2006-185107 filed on Jul. 5, 2006, whose content is incorporated by reference into this application.

### BACKGROUND OF THE INVENTION

The present invention relates to a display device with improved optical characteristics of a display panel, and a method for driving the same, and in particular, relates to a display device applied a liquid crystal to pixels, and a method for driving the same.

An active matrix type liquid crystal display device is utilized as a display device such as a thin-shaped TV or the like, due to having features of being thin-shaped, high definition and low power consumption. However, optical response of liquid crystal is about several tens milliseconds, which requires more time than scanning period of one screen page (one frame), and in the case of displaying a dynamic image, response of liquid crystal cannot follow change in display data, resulting in blurred display. As countermeasure against such a blur, U.S. Pat. No. 6,501,451 (JP-A-11-126050) discloses a method for improving optical response of liquid crystal, by detecting the changed portion of image data per each pixel, and providing the compensation in accordance with the change onto liquid crystal applied voltage. However, in a method of U.S. Pat. No. 6,501,451, although required effect can be expected in the case of display transition from arbitrary tone to intermediate tone, because sufficient voltage compensation is possible, improvement effect of liquid crystal response cannot be expected in the case of display transition close to saturated tone such as maximum tone or minimum tone, because sufficient voltage compensation cannot be provided. To overcome this problem, by setting an applied voltage range of liquid crystal wider than a range used in display, as in a method of U.S. Pat. No. 6,876,347 (JP-A-2002-107694), compensation voltage can be applied even in the case of display transition toward the tone close to saturated tone, and thus liquid crystal response can be improved.

### SUMMARY OF INVENTION

Use of the above technique is capable of improving liquid crystal response even in the case of display transition toward the tone close to saturated tone, however, execution of the compensation by a conventional data driver results in shift of relation between tone and transmittance from required characteristics set to the original data driver. In addition, there was a problem of decrease in display tone number relative to input data tone number. To avoid this problem, development of a new data driver responding to such a compensation range has been required.

It is an object of the present invention to provide a display device, which can obtain the compensation effect of optical response characteristics of liquid crystal and improve the visibility of dynamic image, even in display transition to the vicinity of maximum tone or minimum tone, without decreasing contrast characteristics of a display panel, and no shift of γ (gamma) characteristics of input data, along with no decrease in tone number, and a method for driving the same.

To solve the above-described problem, a range of higher applied voltage (lower applied voltage) is set than maximum (minimum) applied voltage, which provides conventional maximum (minimum) liquid crystal transmittance, and reference voltage is set so that the range can be utilized to compensate liquid crystal response. Furthermore, a γ adjustment means and an inter-tone interpolating means are provided to adjust shift of γ characteristics caused by extension of the applied voltage range.

In accordance with the present invention, there is provided a display device, wherein said display device comprising:

a display panel having a plurality of data lines and a plurality of scanning lines arranged in a matrix way, having pixels arranged corresponding to intersecting points thereof, and having predetermined tone-brightness characteristics;

a first driving circuit which inputs display data of n tones (n: an integer of equal to or larger than 0), and outputs voltage level corresponding to said n tones to said data lines;

a second driving circuit which outputs selected signals to select pixels which should receive said display signals to said scanning lines;

a circuit which enhances optical response characteristics of said pixels, by applying voltage higher than maximum applied voltage of said predetermined tone-brightness characteristics, to said pixels; and

a circuit which converts input display data to output data based on configuration tones set;

wherein tone-brightness characteristics for data processed by the circuit to execute enhancement of said optical response characteristics, and tone-brightness characteristics for the case without execution of enhancement of said optical response characteristics are nearly the same.

According to the present invention, compensation effect of optical response characteristics of liquid crystal can be obtained, even in display transition to the vicinity of maximum tone or minimum tone, without decreasing contrast characteristics of a display panel, and no shift of γ characteristics of input data, along with no decrease in tone number, and visibility of dynamic image can be enhanced.

### BRIEF DESCRIPTION OF THE DRAWINGS

FIG. 1 is block diagram of a liquid crystal display device of a first embodiment.

FIGS. 2A-2B are examples of brightness-input tone characteristics (γ characteristics).

FIGS. 3A-3C are drawings explaining liquid crystal response compensation.

FIGS. 4A-4B are examples of applied voltage-liquid crystal transmittance characteristics.

FIG. 5 is an example of tone-applied voltage relation.

FIGS. 6A-6C are drawings explaining γ adjustment.

FIGS. 7A-7B are drawings explaining inter-tone interpolation.

### DESCRIPTION OF THE EMBODIMENTS

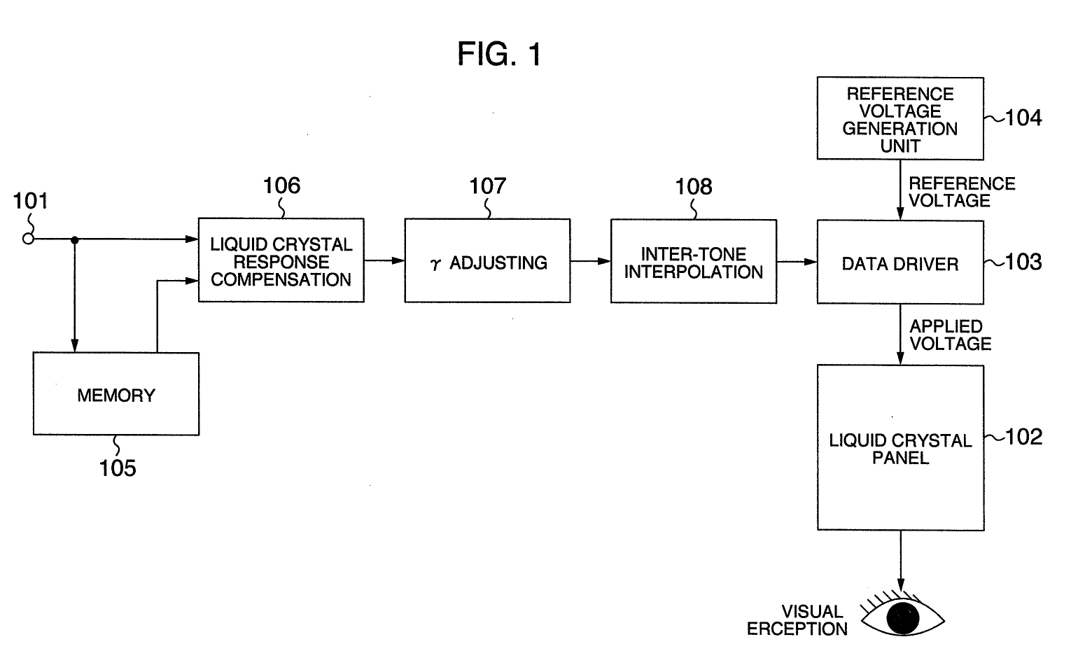

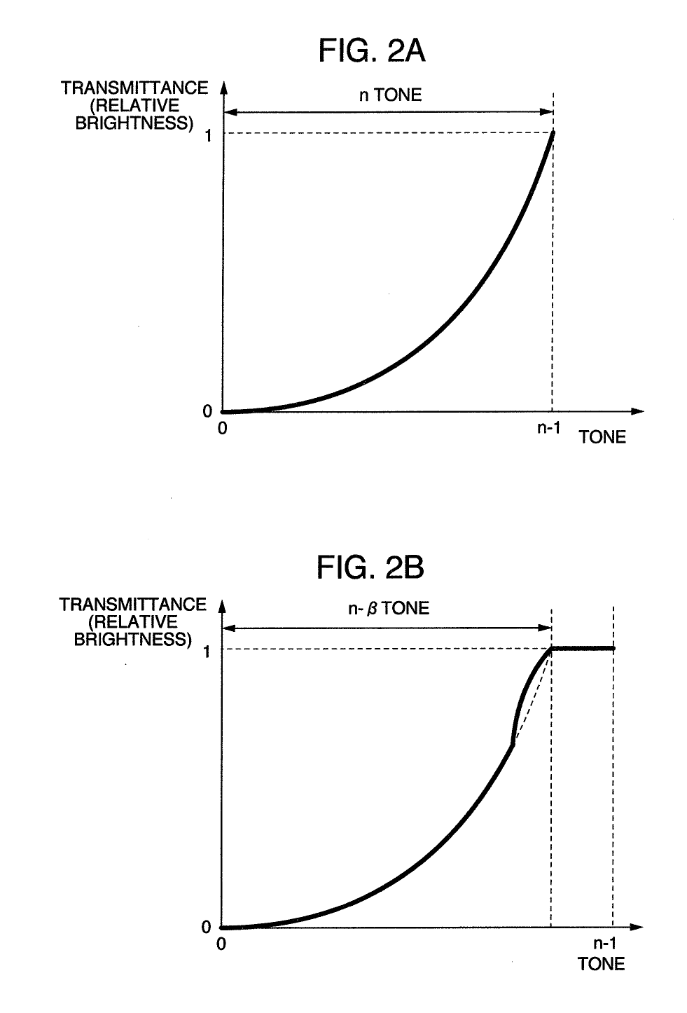

Explanation will be given on an active matrix type liquid crystal display device and a method for driving according to a first embodiment of the present invention, with reference to FIG. 1 to FIG. 7. FIG. 1 is an example of block diagram of a liquid crystal display device of a first embodiment of the present invention. From the system of previous step, image data to be displayed, corresponding to screen display such as color tone or tone or the like, is received into the input image terminal 101, and voltage based on the image data is applied to liquid crystal to control liquid crystal transmittance and to display the image at the liquid crystal panel 102. Relation between liquid crystal transmittance (namely, display brightness) and tone data of image (hereafter, γ characteristics) is set by the data driver 103 and the reference voltage generation unit 104, so as to be predetermined characteristics. For example, in the case of image signals for TV broadcasting, characteristics shown in FIG. 2A is attained as a liquid crystal display device, because γ characteristics copied after a model of human visual feature, as shown in FIG. 2A, is envisioned. It should be noted that γ value of liquid crystal is 2.2.

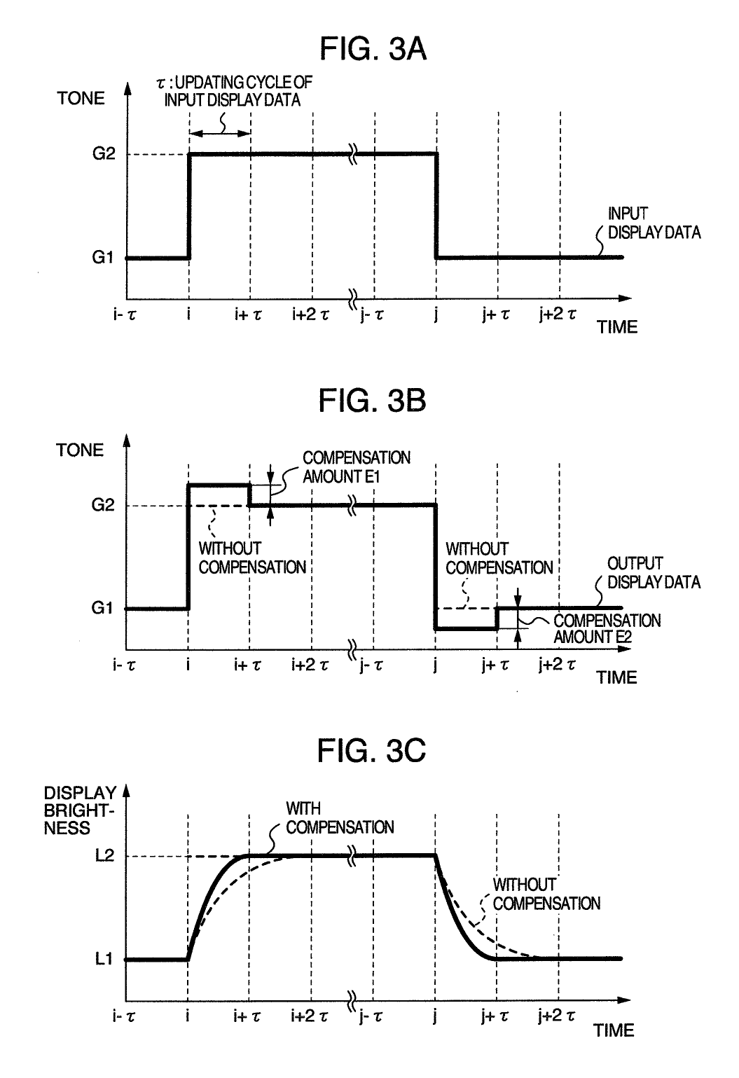

From now on, explanation will be given below on operation of the present embodiment with reference to FIG. 1. By utilization of the memory means 105, which delays, during a certain period, input image data received into the input image terminal 101, image data before predetermined time is obtained. This predetermined time to be delayed is, for example, scanning period of one screen page (updating period of display, one frame period) or the like, and a memory frame, which memories data of one screen page, or compressed data of one screen page, is used as a memory means at this time. This frame memory may be any one as long as a memory means having memory function, such as SDRAM, DRAM, SRAM, FIFO or the like. It should be noted that a plural of screen pages (a plural frame period) may be acceptable instead of one screen page Correction value is calculated from changed portion of data from image data before a predetermined time and present input image data by the memory means 105, and optical response of liquid crystal is improved, by the liquid crystal response compensation means 106, which adds compensation to present image data. Explanation will be given on the liquid crystal response compensation means 106 with reference to an example of FIG. 3. FIG. 3A shows time change of display data focused on a certain pixel. FIG. 3B shows output of the liquid crystal response compensation means 106 corresponding to display data of FIG. 3A. When τ represents an updating cycle of input display data, change in rise from display data tone G1 at the previous frame time (ι−τ) to display data tone G2 at time i is detected at time i, and correction value E1 corresponding to the changed portion is calculated, and the correction value E1 is added to the display data tone G2 at time i, thereby liquid crystal response rate is enhanced by furnishing more excess data change than original case. Similarly in case of change in fall at time j, change in fall from display data tone G2 at the previous frame time (j−τ) to display data tone G1 at time j is detected, and correction value E2 corresponding to the changed portion is calculated, and the correction value E2 is reduced from the display data tone G1 at time j, thereby liquid crystal response rate is enhanced by furnishing more excess data change than original case. A method for calculating correction value includes a table system to directly set correction values based on relation between data of the previous frame and data of the present frame; or a calculation system for calculating based on difference amount between data of the previous frame and data of the present frame, and coefficient; however, any system may be adopted as long as being a system to calculate correction value of liquid crystal response. FIG. 3C shows image of brightness characteristics having liquid crystal response improved by the liquid crystal response compensation means 106.

In a conventional liquid crystal response compensation means, sufficient effect of liquid crystal response compensation could not be obtained in the case of transition to the tone of vicinity of maximum tone due to data processing, because sufficient correction value could not be added to liquid crystal response. Namely, for example, in 8-bit tone expression, in the case of transition from arbitrary intermediate tone to maximum 255-tone, correction value cannot be added to liquid crystal response, because voltage equal to or higher than 255-tone cannot be applied.

In the liquid crystal response compensation means 106 of the present invention, a tone range for compensation is set at larger tone than display maximum tone, so that correction value can be added also at the tone of vicinity of display maximum tone, thereby tone number after the liquid crystal response compensation means 106 increases from input. For example, in the case where monochrome input data is 8-bit tone, a display tone range becomes from 0-tone to 255-tone, and when 32-tone amount is prepared for liquid crystal response compensation, a tone range from 256-tone to 287-tone becomes tone for liquid crystal response compensation, and 8-bit+m (m: an integer equal to or larger than 1) is output as data. Value of “n” may be 1, or 2 or 3. A tone range for compensation differs depending on response characteristics at the vicinity of maximum tone, and when fine adjustment is required, a tone range for compensation may be widened. In addition, also at the vicinity of minimum tone, similar concept is applied. A tone range for compensation is set at smaller tone than display minimum tone, so that subtraction of correction value becomes to be possible also in tone at the vicinity of display minimum tone. Also in this case, tone expression number after the liquid crystal response compensation means 106, increases from that of input.

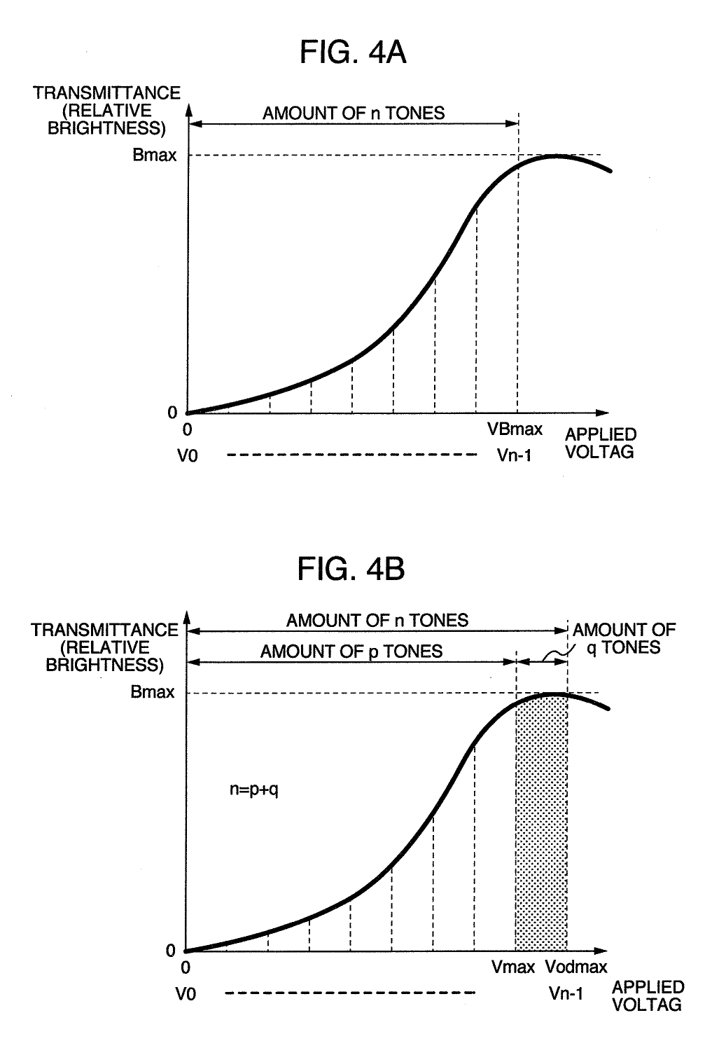

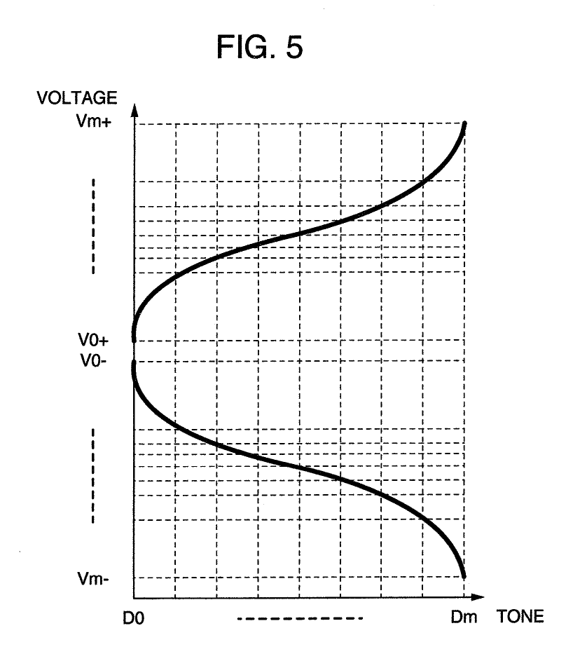

It is necessary to consider a tone range for compensation, in the case where data added with correction value by the liquid crystal response compensation means 106 is displayed at the liquid crystal panel 102, using present liquid crystal data driver IC. The data driver 103 sets a plurality of reference voltages from the reference voltage generation unit 104, and generates applied voltage corresponding to tone data, in consideration of alternating current drive of inherent characteristics of a liquid crystal panel, and applied voltage-transmittance characteristics, so that γ characteristics as shown in FIG. 2A is obtained. FIG. 4 shows an example of applied voltage-liquid crystal transmittance characteristics of normally black mode liquid crystal, and FIG. 5 shows an example of tone-applied voltage relation of the data driver 103. Usually, in consideration of display contrast efficiency and view field angle, reference voltage is given so that voltage at the vicinity of maximum transmittance is maximum applied voltage, and voltage at the vicinity of minimum transmittance is minimum applied voltage, as shown in FIG. 4A. In the reference voltage generation unit 104 of the present invention, maximum applied voltage is shifted to higher voltage than applied voltage giving maximum transmittance, by the liquid crystal response compensation means 106, in response to a tone data of increased amount of a tone range for compensation, as shown by FIG. 4B. In this way, an applied voltage range, which is set from characteristics, corresponding to from the vicinity of minimum transmittance to the vicinity of maximum transmittance, is utilized as a conventional display range, and a maximum applied voltage range shifted from applied voltage corresponding to maximum transmittance is made to correspond to tone data of increased amount for compensation, by which contrast efficiency can be maintained as conventionally, and effect of liquid crystal response compensation can be obtained also at the vicinity of maximum tone.

However, by the shift of reference voltage toward high voltage side, drift in γ characteristics is generated in conventional tone-applied voltage relation. For example, shift of only maximum reference voltage provides γ characteristics as shown in FIG. 2B. In addition, response to an increased voltage range by a data driver having the same tone number as that of input results in decrease in tone number of a display range.

To solve these problems, drift between y characteristics generated by range extension to over maximum display tone of the liquid crystal response compensation means 106, and γ characteristics set by the data driver 103 is adjusted by using the γ adjusting means 107, and further, decrease in tone number is prevented by the inter-tone interpolation means 108.

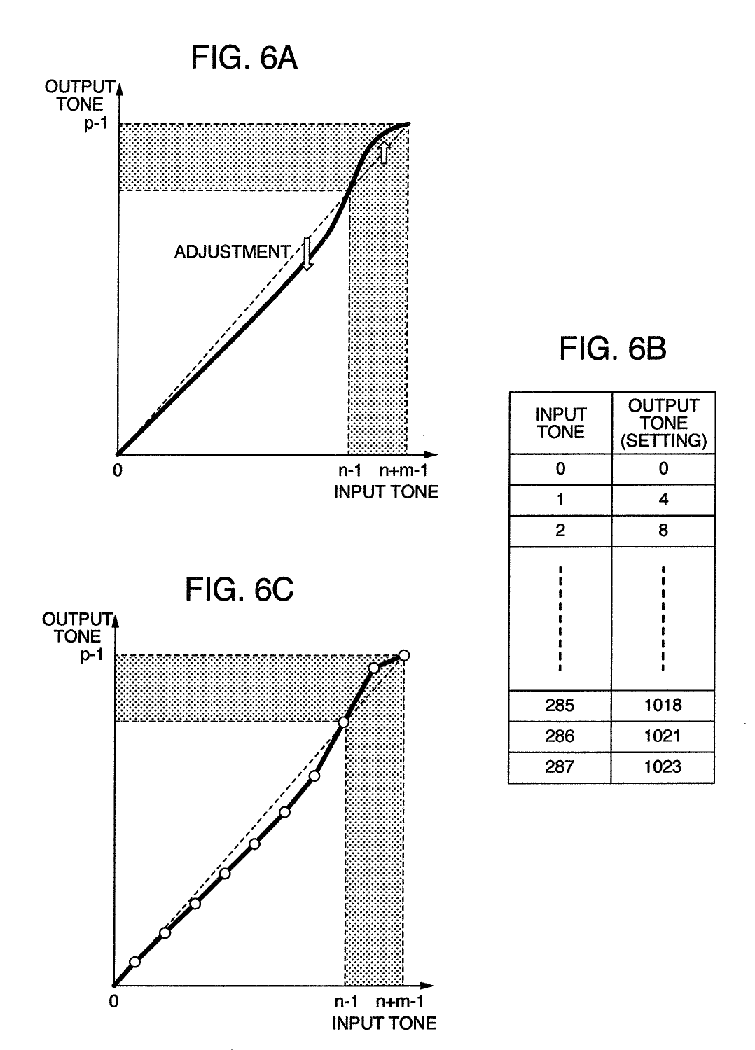

The γ adjusting means 107 provides a circuit, which is capable of adjusting output tone by setting, relative to input tone, as shown in FIG. 6A. For example, the adjustment is attained by a look-up table system (LUT) as shown in FIG. 6B, which sets directly output tone by each of input tones; or a broken line system as shown in FIG. 6C, which adjusts output tone by controlling arbitrary points. In addition, in the γ adjusting means 107, by increasing output tone relative to input tone, decrease in tone caused by γ adjustment is prevented, and also, a more fine adjustment range can be attained. In an example of FIG. 6B, output is executed by γ adjustment from 0-tone to 1024-tone relative to input of from 0-tone to 288-tone.

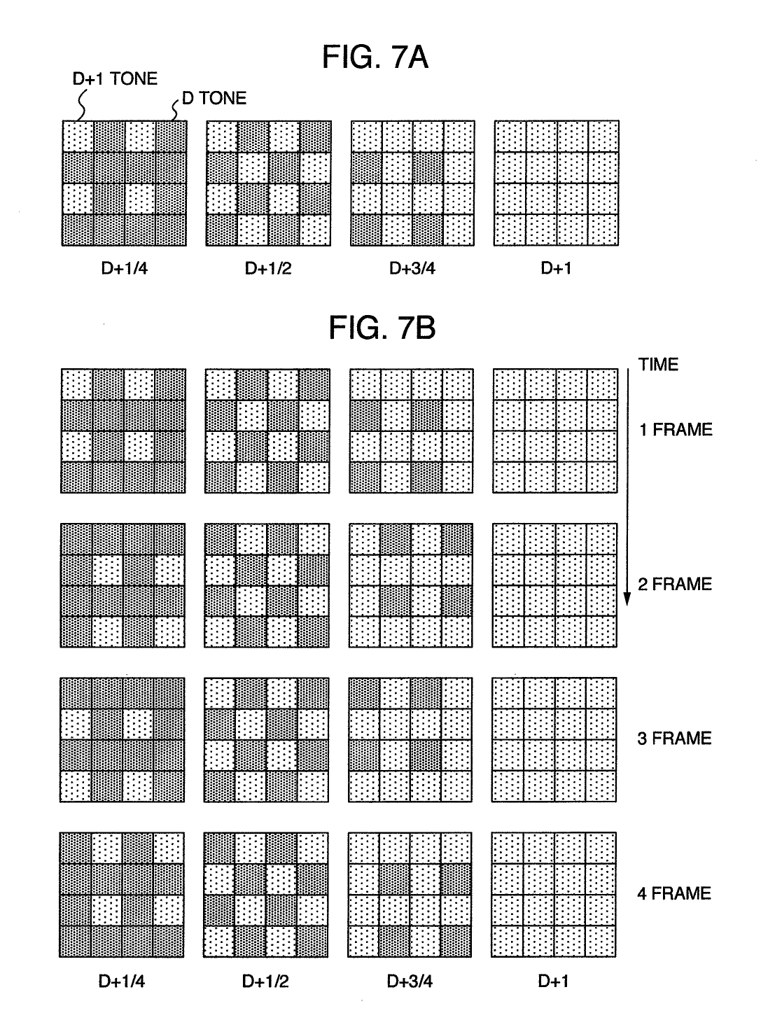

The inter-tone interpolation means 108 is a means to convert data generated by the γ adjustment means 107 to bit number that the data driver 103 has. As an example, for 10-bit output from the γ adjustment means 107, the data driver 103 is assumed to have tone expression capability of 8-bit. In this case, the inter-tone interpolation means 108 converts to be pseudo-display of 10-bit by using dithering processing or FRC (frame rate control). Explanation will be given on such an example by using FIG. 7.

FIG. 7A is an example of dithering processing for expressing intermediate tone by diffusing appearance frequency of shading in a plane direction.

In the case where the lowest two bits of 10-bit data are expressed as 0, ¼, ½ and ¾, 10-bit data can be expressed as D+¼, D+½, D+¾ and D+1. In the case where this is expressed by dithering, row position and line position of a matrix-like display are counted by a binary counter, which counts each of them as 0, 1, 0, 1 - - - , and at the same time, when 10-bit data is tone D+¼, for a position with a row position of 0 and line position of 0, it is expressed as tone D+1 that can be expressed by 8-bit; and for other expression position, it is expressed as tone D. As a result, a matrix composed of 2 pixels in a row direction, and 2 pixels in a line direction becomes to have tone D+1 of 1 pixel and tone D of 3 pixels, and tone D+¼ in average can be expressed. Similarly, when 10-bit data is tone D+½, for a display position with additional value of a row position and line position of even number, it is expressed as tone D+1; and display position with additional value of odd number, it is expressed as tone D. As a result, a matrix composed of 2 pixels in a row direction, and 2 pixels in a line direction becomes to have tone D+1 of 2 pixels and tone D of 2 pixels, and tone D+½ in average can be expressed. In this way, by specifying shading pattern based on row position and line position of a display, dithering processing can be attained. It should be noted that shading pattern, and input/output bit number for the inter-tone interpolation means 108 are not especially limited.

FIG. 7B is an example of FRC for expressing intermediate tone by diffusing appearance frequency of shading in a plane direction and in a time direction, in the case where the data driver 103 is 8-bit for 10-bit data. In FRC, row position, line position and also frame number of a display are counted by a quaternary counter, which expresses as 0, 1, 2, 3, 0, 1, 2, 3, - - - . In the case when 10-bit data is tone D+¼, for a frame counter value of 0, a position with additional value of a row position and line position of 0 is expressed as tone D+1, and other pixels are expressed as tone D; for a frame counter value of 1, a position with additional value of a row position and line position of 2 is expressed as tone D+1, and other pixels are expressed as tone D; for a frame counter value of 2, a position with a row position of 1 and a line position of 0 is expressed as tone D+1, and other pixels are expressed as tone D; and for a frame counter value is 3, a position with a row position of 0 and a line position of 1 is expressed as tone D+1, and other pixels are expressed as tone D. As a result, a matrix composed of 2 pixels in a row direction, and 2 pixels in a line direction becomes, in a certain frame time, to have tone D+1 of 1 pixel and tone D of 3 pixels, and tone D+¼ in average, and for any pixel in 4 frame times, tone D+1 is expressed for 1 frame time, and tone D is expressed for 3 frame times, and thus tone D+¼ can be expressed in an area direction and in a time direction. Similarly, in the case when 10-bit data is tone D+½, for a frame counter value of even number, a position with additional value of a row position and line position of even number is expressed as tone D+1, and other pixels are expressed as tone D; and for a frame counter value of odd number, a position with additional value of a row position and line position of odd number is expressed as tone D+1, and other pixels are expressed as tone D. As a result, a matrix composed of 2 pixels in a row direction, and 2 pixels in a line direction becomes, in a certain frame time, to have tone D+1 of 2 pixel and tone D of 2 pixels, and tone D+½ in average, and for any pixel in 2 frame times, tone D+1 is expressed for 1 frame time, and tone D is expressed for 1 frame time, and thus tone D+½ can be expressed in an area direction and in a time direction. In this way, by specifying shading pattern based on row position, line position and frame time of a display, FRC can be attained. It should be noted that shading pattern, and input/output bit number for the inter-tone interpolation means 108 are not especially limited.

By this inter-tone interpolation means 108, tone number increased by the liquid crystal response compensation means 106 and the γ adjusting means 107 is converted to tone number corresponding to the data driver 103. For example, an 8-bit input data is converted to a 10-bit data by the liquid crystal response compensation means 106 and the γ adjusting means 107, and converted to an 8-bit data, which enables 10-bit equivalent expression, by the inter-tone interpolation means 108, and thus provides tone number responding to the data driver 103.

In this way, by the γ adjusting means 107, drift of γ characteristics caused by the liquid crystal response compensation means 106 is adjusted, and decrease in tone caused by the liquid crystal response compensation means 106 and the γ adjusting means 107 is prevented by the inter-tone interpolation means 108, by which effect of liquid crystal response compensation can be obtained even at the vicinity of maximum tone by using a conventional data driver IC.

Explanation was given above mainly on the vicinity of maximum tone, however, effect of liquid crystal response compensation can be obtained even at the vicinity of minimum tone by using a conventional data driver IC, in the same thought.

The present invention is suitable to an active matrix type liquid crystal display device and a method for driving, however, it is also applicable to other display devices and methods for driving.

A display device of the present invention is utilized in a liquid crystal display device such as a liquid crystal TV, a liquid crystal display or the like.

It should be further understood by those skilled in the art that although the foregoing description has been made on embodiments of the invention, the invention is not limited thereto and various changes and modifications may be made without departing from the spirit of the invention and the scope of the appended claims.

1. A display device, wherein said display device comprising:
a display panel having a plurality of data lines and a plurality of scanning lines arranged in a matrix way, having pixels arranged corresponding to intersecting points thereof, and having predetermined tone-brightness characteristics;
a first driving circuit which inputs display data of n tones (n: an integer of equal to or larger than 0), and outputs voltage level corresponding to said n tones to said data lines;
a second driving circuit which outputs selected signals to select pixels which should receive said display signals to said scanning lines;
a circuit which enhances optical response characteristics of said pixels, by applying voltage higher than maximum applied voltage of said predetermined tone-brightness characteristics, to said pixels; and
a circuit which converts input display data to output data based on configuration tones set;
wherein tone-brightness characteristics for data processed by the circuit to execute enhancement of said optical response characteristics, and tone-brightness characteristics for the case without execution of enhancement of said optical response characteristics are nearly the same.

2. A display device, wherein said display device comprising:
a display panel having a plurality of data lines and a plurality of scanning lines arranged in a matrix way, having pixels arranged corresponding to intersecting points thereof, and having predetermined tone-brightness characteristics;
a first driving circuit which receives display data of n tones (n: an integer of equal to or larger than 0), and outputs voltage level corresponding to said n tones to said data lines;
a second driving circuit which outputs selected signals to select pixels which should receive said display signals to said scanning lines;
a circuit which enhances optical response characteristics of said pixels, by applying voltage higher than maximum applied voltage of said predetermined tone-brightness characteristics, to said pixels; and
a circuit which displays tone number more than at least n tones, by using only p tones (p: an integer satisfying 0≦p<n) among n tones, in voltage level of said n tones, and by area-wise diffusion control of voltage level of p tones.

3. The display device according to claim 2, wherein said display device comprising a circuit which displays tone number more than at least n tones, by using only p tones (p: an integer satisfying 0≦p<n) among n tones, in voltage level of said n tones, and by time-wise diffusion control of voltage level of p tones.

4. A display device comprising a display panel with a plurality of pixels, and a driving circuit to drive said display panel, wherein said display device comprising:
an over drive circuit which inputs an N-bit display data (N: an integer equal to or larger than 1), compensates said display data, based on correction value corresponding to display data before one or a plurality of frames of period, and outputs an (N+m) bit display data added with m-bit (m: an integer of equal to or larger than 1) to an N-bit display data;
a γ adjusting circuit to adjust y characteristics of said (N+m) bit display data from said over drive circuit; and
an interpolating circuit which interpolates inter-tone of said (N+m) bit display data adjusted by said γ adjusting circuit, extends said (N+m) bit display data to M-bit display data (M: an integer larger than (N+m)), and converts said M-bit display data to said N-bit display data, so that said display panel is capable of pseudo-displaying said M-bit display data by said N-bit display data;
and said driving circuit inputs said N-bit display data after conversion.

5. The display device according to claim 4, wherein said interpolating circuit converts said M-bit display data to said N-bit display data by dithering processing, or converts said M-bit display data to said N-bit display data, so that said display panel is capable of pseudo-displaying said M-bit display data by frame rate control.

6. A method for driving a display device comprising:
a display panel having a plurality of data lines and a plurality of scanning lines arranged in a matrix way, having pixels arranged corresponding to intersecting points thereof, and having predetermined tone-brightness characteristics;
a first driving circuit which inputs display data of n tones (n: an integer of equal to or larger than 0), and outputs voltage level corresponding to said n tones at said data lines;
a second driving circuit which outputs selected signals to select pixels which should receive said display signals to said scanning lines;
a circuit which enhances optical response characteristics of said pixels, by applying voltage lower than minimum applied voltage of said predetermined tone-brightness characteristics, to said pixels; and
a circuit which converts input display data to output data based on configuration tones set, wherein tone-brightness characteristics for data processed by the circuit to execute enhancement of said optical response characteristics, and tone-brightness characteristics for the case without execution of enhancement of said optical response characteristics are nearly the same.

7. A method for driving a display device comprising:
a display panel having a plurality of data lines and a plurality of scanning lines arranged in a matrix way, having pixels arranged corresponding to intersecting points thereof, and having predetermined tone-brightness characteristics;
a first driving circuit which receixes display data of n tones (n: an integer of equal to or larger than 0), and outputs voltage level corresponding to said n tones at said data lines;
a second driving circuit which outputs selected signals to select pixels which should receive said display signals to said scanning lines; and
a circuit which enhances optical response characteristics of said pixels, by applying voltage lower than minimum applied voltage of said predetermined tone-brightness characteristics, to said pixels, wherein tone number more than at least n tones is displayed, by using only p tones (p: an integer satisfying 0≦p<n) among n tones, in voltage level of said n tones, and by area-wise diffusion control of voltage level of p tones.

8. The method for driving a display device according to claim 7, wherein tone number more than at least n tones is displayed, by using only p tones (p: an integer satisfying 0≦p<n) among n tones, in voltage level of said n tones, and by time-wise diffusion control of voltage level of p tones.

9. A method for driving a display device comprising a display panel having a plurality of pixels, and a driving circuit to drive said display panel, wherein said method comprising the step:
to input an N-bit display data (N: an integer equal to or larger than 1), compensate said display data, based on correction value corresponding to display data before one or a plurality of frames of period, and generate an (N+m) bit display data added with m-bit (m: an integer of equal to or larger than 1) to an N-bit display data;
to adjust γ characteristics of said (N+m) bit display data;
to interpolate inter-tone of said (N+m) bit display data adjusted, and extend said (N+m) bit display data to M-bit display data (M: an integer larger than (N+m));
to convert said M-bit display data to said N-bit display data, so that said display panel is capable of pseudo-displaying said M-bit display data by said N-bit display data; and
to input said N-bit display data after conversion to said drive circuit.

10. The method for driving a display device according to claim 9, wherein said M-bit display data is converted to said N-bit display data by dithering processing, or said M-bit display data is converted to said N-bit display data, so that said display panel is capable of pseudo-displaying said M-bit display data by frame rate control.
